(19) United States
(12) Patent Application Publication
(10) Pub. No.: US 2025/0064559 A1
(43) Pub. Date: Feb. 27, 2025

(54) DENTAL IMPLANT

(71) Applicant: DENTIPLE INC., Busan (KR)

(72) Inventors: Ji Hyoung YOUN, Busan (KR); Jang Hoon YOUN, Busan (KR); Jong Hyun YOUN, Busan (KR)

(73) Assignee: DENTIPLE INC., Busan (KR)

(21) Appl. No.: 18/720,667

(22) PCT Filed: Dec. 1, 2022
(86) PCT No.: PCT/KR2022/019315

§ 371 Date: Jun. 17, 2024

(30) Foreign Application Priority Data
Dec. 22, 2021 (KR) 10-2021-0185318
Jul. 21, 2022 (KR) 10-2022-0089977
Nov. 3, 2022 (KR) 10-2022-0145417

(51) Int. Cl. A61C 8/00; A61C 5/70

(52) U.S. Cl. CPC A61C 8/00; A61C 5/70

(57) ABSTRACT

The present disclosure relates to a dental implant capable of minimizing the use of an adhesive, such as cement, to fix a crown in position, the dental implant comprising: a fixture part which is implanted in the alveolar bone; an abutment part which is coupled to the upper portion of the fixture part; a crown part which is coupled to surround the abutment part in the direction from top to bottom; and a fixing part which is fastened through the crown part and the abutment part and is provided such that the longitudinal axis thereof intersects the longitudinal axis of the abutment part.

### TECHNICAL FIELD

The present disclosure relates to a dental implant and, more particularly, to a dental implant, which is an artificial tooth, to replace a missing tooth.

### BACKGROUND ART

As an artificial tooth to reinforce a lost tooth, a dental implant is widely used. Such a dental implant has the structure of an overall assembly and combination of a fixture, which is a type of artificial tooth root, implanted in the alveolar bone, an abutment which is coupled to the upper part of the fixture, and a crown, which is a tooth-shaped prosthesis, coupled to the upper part of the abutment.

As an example of the dental implant described above, a preceding Korean Patent Application Publication No. 10-2013-0103090 discloses CROWN OF DENTAL IMPLANT AND DENTAL IMPLANT COMPRISING SAME. In addition, according to the above-described prior document, design details of the implant to facilitate detachment of crown are disclosed, and the effect capable of easily replacing a crown damaged by masticatory activities is disclosed.

Meanwhile, as a specific method for fixing the position of the crown, the prior document discloses an adhesive layer, a type of adhesive. More specifically, according to the prior document, a through hole is formed in a direction crossing the longitudinal axis of the crown, and a portion of the abutment is accommodated in the through hole. Next, by filling and hardening dental cement in the through hole, the adhesive layer is formed to bond the crown and the abutment to each other by an adhesive method, thereby allowing the crown to be securely fixed to the abutment.

However, such an adhesive has the disadvantage of being relatively low in rigidity and susceptible to thermal deformation. In addition, according to the prior document, the adhesive layer is inevitably exposed to the outside through the open upper surface of the crown, and as a result, the upper surface of the adhesive layer is inevitably exposed to the masticatory action of the oral cavity, resulting in a high risk of damage and short lifespan. In addition, the above-mentioned adhesive is removed only by a method such as heating or scratching, and such a removal method causes a significant physical burden on a person being treated and causes the problem of easily causing unintentional damage to surrounding human body parts.

In addition, according to the prior document, the above-mentioned adhesive layer is bound to be formed on the entire longitudinal axis of the crown or the entire inner surface of the crown, and thus occupies a significant proportion of the entire area of the implant, thereby highlighting the various disadvantages mentioned above more seriously.

### SUMMARY OF INVENTION

### Technical Problem

The present disclosure has been made to solve the above problems, and is intended to provide a dental implant capable of minimizing the use of an adhesive, such as cement, to fix the position of a crown.

### Solution to Problem

A dental implant according to the present disclosure includes a fixture part implanted in the alveolar bone, an abutment part coupled to an upper portion of the fixture part, a crown part coupled to the abutment part to cover the abutment part in a direction downward from an upper portion thereof, and a fixing part fastened to the crown part and the abutment part by passing therethrough and provided such that a longitudinal axis of the fixing part intersects a longitudinal axis of the abutment part.

In addition, the abutment part may include an abutment sealing groove formed as a recessed structure along a circumferential direction of an outer circumferential surface thereof, and an abutment sealing part fastened to the abutment sealing groove, the crown part may include a crown sealing groove formed as a recessed structure on an inner circumferential surface thereof such that the crown sealing groove is in surface contact with an outer surface of the abutment sealing part protruding to the outside of the abutment sealing groove, and the abutment sealing part may be in close contact with the abutment sealing groove and the crown sealing groove through an elastic restoration action.

In addition, the dental implant may further include a reinforcing part inserted into the abutment part and penetrated by the fixing part.

In addition, the abutment part may include an abutment fastening hole formed through the abutment part along a longitudinal direction thereof from an upper outer surface thereof, an abutment middle hole formed in a direction intersecting with a longitudinal axis of the abutment part, and at least one key groove extending downward while the key groove has a structure extending from an upper open surface edge of the abutment fastening hole in a radially outward direction of the abutment fastening hole, the crown part may include a crown middle groove formed in a direction intersecting with a longitudinal axis thereof, the reinforcing part may include a middle through hole formed in a direction intersecting with a longitudinal axis thereof, and a key protrusion part formed as a protruding structure on an outer circumferential surface thereof to guide mutual communication of the abutment middle hole and the middle through hole, with the key protrusion part being coupled to the key groove, and the fixing part may be fastened through the crown middle groove, the abutment middle hole, and the middle through hole.

In addition, the fixture part may include a fixture screw groove formed along a longitudinal direction thereof from an upper outer surface thereof, the abutment part may include a coupling screw configured to fix the abutment part to the fixture part by engaging with the abutment fastening hole and the fixture screw groove, and the reinforcing part may be provided between an upper outer surface of the coupling screw and an upper inner surface of the crown part.

Provided is a dental implant including a fixture part implanted in the alveolar bone, an abutment part provided on an upper portion of the fixture part, a healing sleeve part provided to cover the abutment part downward from an upper portion thereof, a crown part provided to cover the healing sleeve part downward from an upper portion thereof, and a fixing part fastened through the crown part, the healing sleeve part, and the abutment part and provided such that a longitudinal axis of the fixing part intersects with an implanting direction of the fixture part.

The healing sleeve part may include an internal insertion part extending from an inner ceiling surface thereof facing an upper opening of the abutment part, and protruding downward to be inserted into the abutment part, and the fixing part may penetrate the internal insertion part.

The abutment part may extend upward from an upper end of the fixture part.

The abutment part may extend to correspond to a height position of a highest end of the gingiva.

The fixture part may include a fixture screw groove formed along a longitudinal direction thereof from an upper outer surface thereof, the abutment part may include an abutment body on the upper portion of the fixture part, an abutment fastening hole formed up and down along a longitudinal direction thereof and having opposite open ends, and a coupling screw inserted into the abutment fastening hole and the fixture screw groove to be screwed to the fixture screw groove so that the abutment body is fixed to the fixture part, and an internal insertion part of the healing sleeve part may be inserted into the abutment fastening hole and elastically press an upper surface of the coupling screw downward.

### Effects of Invention

According to the dental implant of the present disclosure, the fixing part is fastened in a direction that intersects the longitudinal axis of an entire implant, and the crown part can be fastened to the abutment part by the fixing part. Accordingly, there is no need to open an upper outer surface, which is the chewing surface of the crown, for fastening a separate fastener, thereby minimizing the introduction of foreign substances into the implant or damage to the implant due to masticatory activities in the oral cavity.

In addition, by providing the fixing part described above, there is no need for a separate adhesive such as cement, thereby minimizing various problems caused by the use of cement.

### BRIEF DESCRIPTION OF DRAWINGS

FIG. 1 is a perspective view illustrating a dental implant according to a first embodiment of the present disclosure.

FIGS. 2a and 2b are exploded perspective views of the dental implant according to the present disclosure.

FIG. 3 is a front cross-sectional view of the dental implant of illustrated in FIG. 1.

FIG. 4 is a flowchart illustrating the assembly process of the dental implant according to the present disclosure.

FIG. 5 is a view illustrating the coupled state of a fixture part and an abutment part illustrated in FIG. 3.

FIG. 6 is a view illustrating a state in which a reinforcing part is additionally coupled in the state illustrated in FIG. 5.

FIG. 7 is a view illustrating the upper surface of FIG. 6.

FIGS. 8a and 8b are views illustrating a state in which a healing sleeve part is additionally combined in the state illustrated in FIG. 6.

FIG. 9 is a view illustrating a state in which a crown part is additionally combined in the state illustrated in FIG. 6.

FIG. 10 is a view illustrating a state in which a filling member is filled in an entrance groove illustrated in FIG. 3.

FIG. 11 is an exploded perspective view illustrating an abutment part according to a second embodiment of the present disclosure.

FIG. 12 is a cross-sectional view illustrating the embodiment of the abutment part illustrated in FIG. 10.

FIG. 13 is a perspective view illustrating a dental implant according to a third embodiment of the present disclosure.

FIG. 14 is an exploded perspective view of FIG. 13.

FIG. 15 is a front cross-sectional view of FIG. 13.

FIG. 16 is a view illustrating the coupled state of the fixture part and the abutment part illustrated in FIG. 15.

FIGS. 17a and 17b are views illustrating a state in which the healing sleeve part is additionally combined in the state illustrated in FIG. 16.

FIG. 18 is a cross-sectional view relative to a state viewed from A-A′ illustrated in FIG. 17a.

FIG. 19 is a view illustrating a state in which the crown part is additionally combined in the state illustrated in FIG. 17a.

FIG. 20 is a view illustrating a state in which a filling member is filled in a crown entrance groove illustrated in FIG. 15.

FIG. 21 is a front cross-sectional view illustrating a dental implant according to a fourth embodiment of the present disclosure.

FIG. 22 is a front cross-sectional view illustrating a dental implant according to a fifth embodiment of the present disclosure.

### DESCRIPTION OF EMBODIMENTS

Prior to the specific description of the present disclosure, specific details for implementing the present disclosure are included in embodiments and drawings described below, and the same reference numerals used throughout this specification refer to the same components.

In addition, in this specification, singular expressions also include plural expressions unless specifically stated in a phrase.

Hereinafter, a dental implant according to the present disclosure will be described with reference to the drawings.

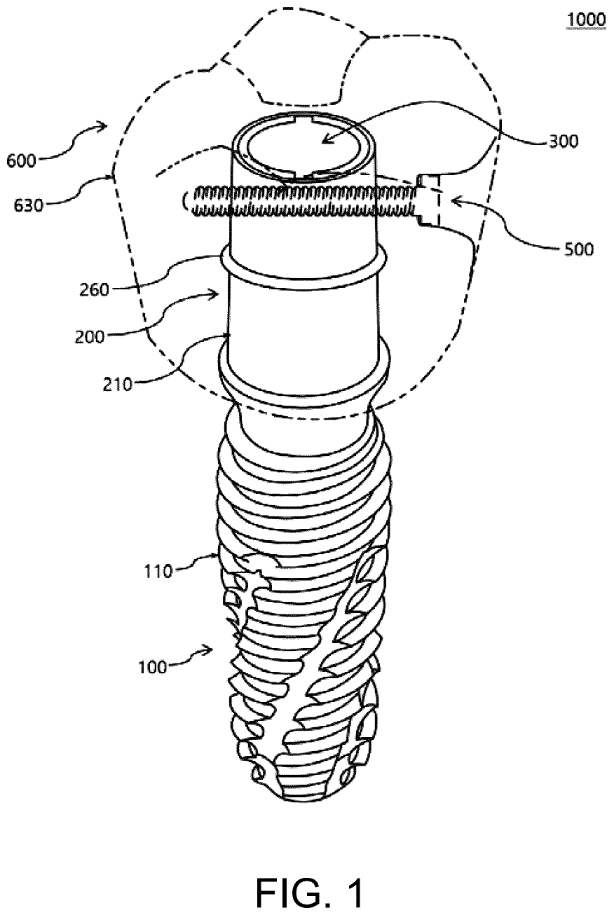

FIG. 1 is a perspective view illustrating a dental implant according to a first embodiment of the present disclosure.

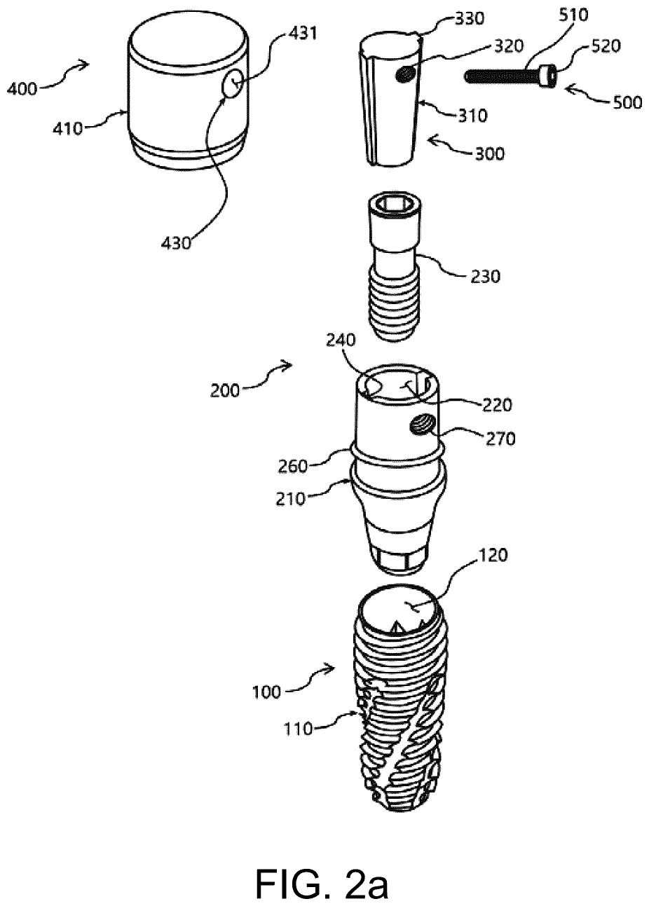

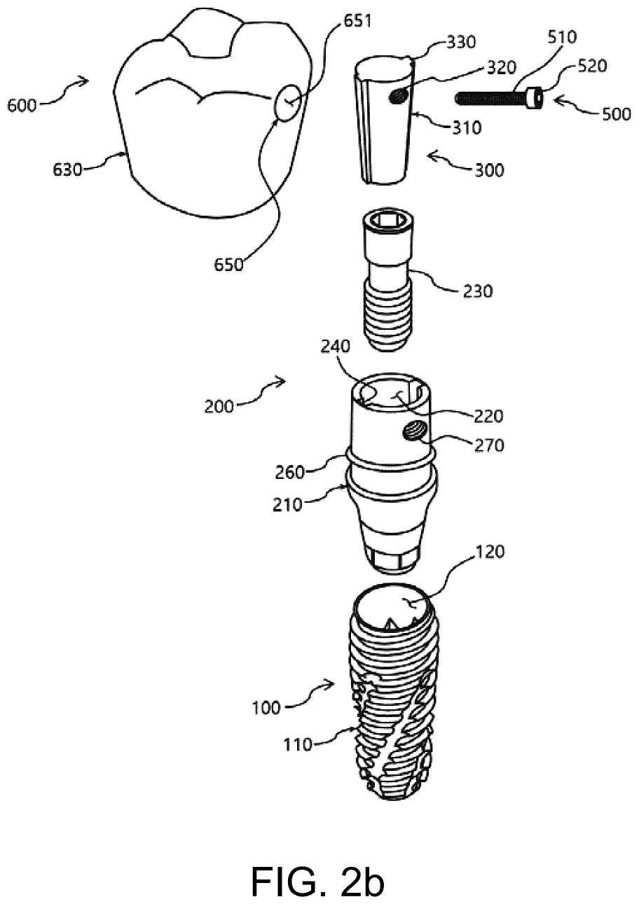

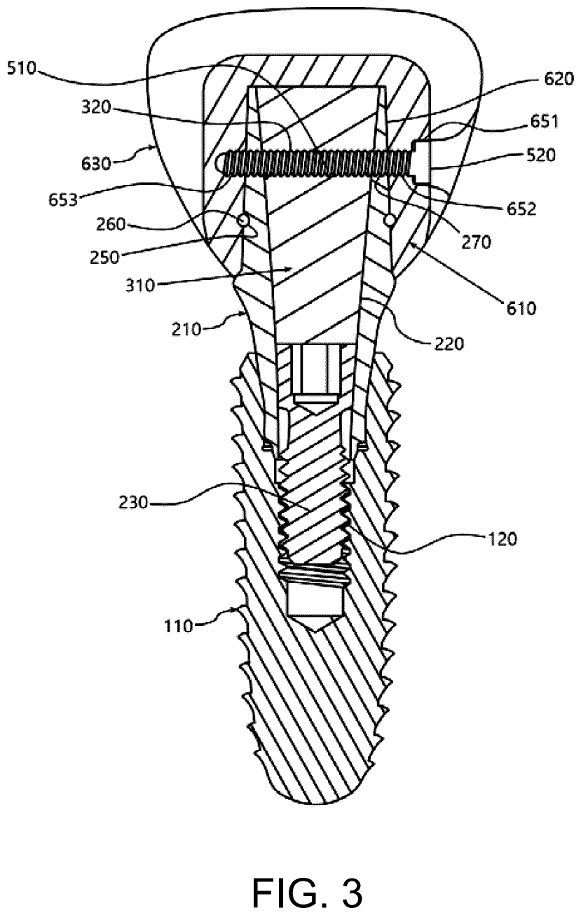

Additionally, FIGS. 2a and 2b are exploded perspective views of the dental implant according to the present disclosure. Additionally, FIG. 3 is a front cross-sectional view of the dental implant of illustrated in FIG. 1.

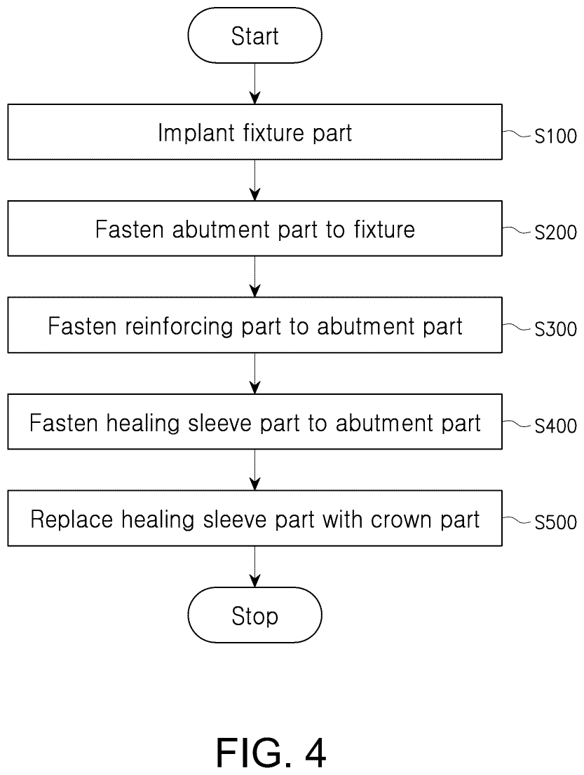

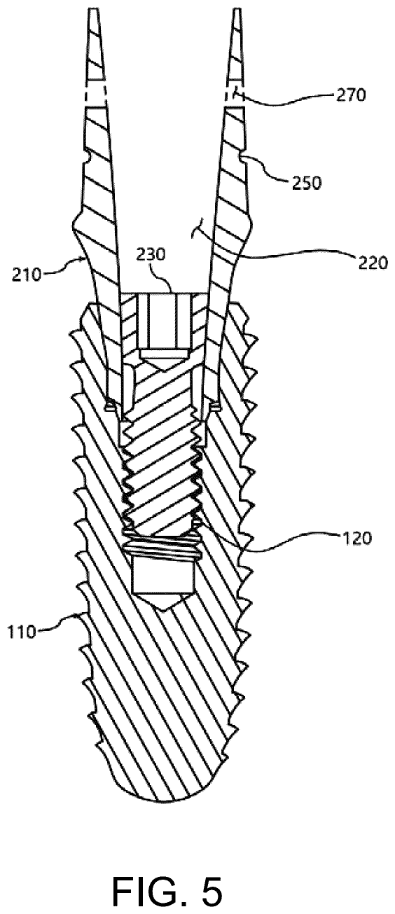

Additionally, FIG. 4 is a flowchart illustrating the assembly process of the dental implant according to the present disclosure. Additionally, FIG. 5 is a view illustrating the coupled state of a fixture part and an abutment part illustrated in FIG. 3.

Referring to FIGS. 1 to 5, the dental implant 1000 according to the present disclosure may include a fixture part 100, an abutment part 200, a reinforcing part 300, a healing sleeve part 400, a fixing part 500, and a crown part 600. In addition, the dental implant 1000 may be operated and assembled through implanting a fixture S100, fastening an abutment S200, inserting a reinforcement S300, fastening a healing sleeve S400, and fastening a crown S500.

First, in the implanting of a fixture S100, the process of implanting the fixture part 100 into the alveolar bone of a person who undergoes a medical procedure may proceed. In addition, the fixture part 100 may include a fixture body 110 and a fixture screw groove 120.

More specifically, the fixture body 110 has an appearance that corresponds to the fixture of the dental implant, which has a type of screw structure. In addition, the fixture body 110 may be implanted into the alveolar bone of a person who undergoes a medical procedure by using various dental tools (not shown), such as a dental driver.

Additionally, the fixture screw groove 120 is formed in a groove structure along the longitudinal direction of the fixture body 110 from the upper outer surface of the fixture body 110. In addition, a predetermined screw groove structure may be formed along the longitudinal direction of the fixture screw groove 120 on the inner circumferential surface of a circumferential direction thereof.

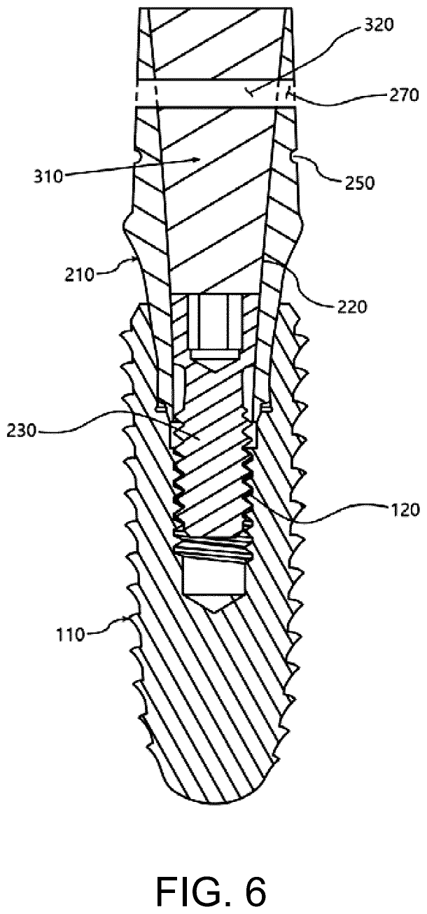

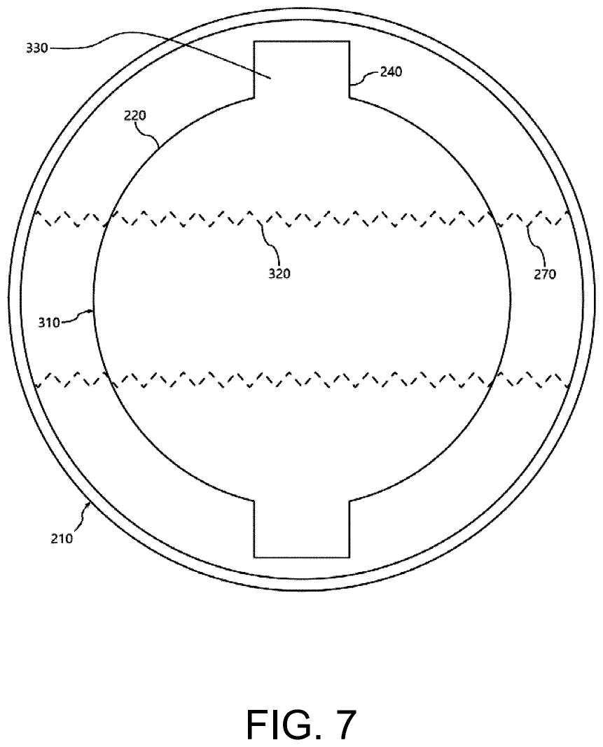

Next, FIG. 6 is a view illustrating a state in which the reinforcing part is additionally coupled in the state illustrated in FIG. 5, and FIG. 7 is a view illustrating the upper surface of FIG. 6.

Referring to FIGS. 6 and 7, the abutment part 200 may include an abutment body 210, an abutment fastening hole 220, a coupling screw 230, a key groove 240, an abutment sealing groove 250, an abutment sealing part 260, and an abutment middle hole 270. Additionally, in the fastening of an abutment S200, a process of coupling the abutment part 200 and the fixture part 100 to each other may be performed.

More specifically, the abutment body 210 corresponds to an abutment in the dental implant. In addition, the abutment body 210 may be inserted into and accommodated inside the fixture screw groove 120 from the lower end of the abutment body 210 to a predetermined height position thereof. That is, a portion of the lower outer surface of the abutment body 210 may be accommodated inside the fixture screw groove 120.

Additionally, the abutment fastening hole 220 is formed in a hole structure along the longitudinal direction of the abutment body 210, and further, the upper and lower outer surfaces of the abutment body 210 are open.

Additionally, after the coupling screw 230 is inserted into the upper opening of the abutment fastening hole 220 and moves downward, an end of the coupling screw 230 is inserted into the fixture screw groove 120. In addition, a thread structure corresponding to the screw groove structure of the fixture screw groove 120 is formed on the outer circumferential surface of the coupling screw 230. Through the engagement of the screw groove structure with the thread structure, the coupled state of the fixture part 100 with the abutment part 200-1 may be securely fixed.

Here, the diameter of the fixture screw groove 120 and the diameter of the opening of the lower end part of the abutment fastening hole 220 may correspond to each other, and the diameter of the threaded body of the coupling screw 230 may also correspond to the diameter of the fixture screw groove 120.

Additionally, a head part of the coupling screw 230 is formed to have a larger diameter than the threaded body, and correspondingly, the abutment fastening hole 220 may also be formed to have an inner diameter increased compared to the opening of the lower end part thereof.

Through the above-described variable diameter structure, a kind of stepped structure is formed on the lower end of the abutment body 210. Additionally, when the coupling screw 230 moves downward, the head part of the coupling screw 230 is spatially interfered with by the stepped structure of the lower end of the abutment body 210 described above.

Additionally, as such a spatial interference structure for the coupling screw 230 is provided, as long as a screw coupling between the threaded body of the coupling screw 230 and the threaded groove of the fixture screw groove 120 is maintained, the coupled state of the abutment body 210 with the fixture body 110 may be securely maintained.

Additionally, the key groove 240 has a structure extending from the upper open surface edge of the abutment fastening hole 220 in a radially outward direction of the abutment fastening hole 220. In addition, the key groove 240 may have a predetermined length and extend downward, and the longitudinal axis of the key groove 240 may be parallel to the longitudinal axis of the abutment fastening hole 220.

Additionally, the abutment sealing groove 250 is formed in a recessed structure along the circumferential direction of the outer circumferential surface of the abutment body 210.

Additionally, the abutment sealing part 260 is formed in a type of O-ring structure and is coupled to the abutment sealing groove 250. In this case, the outer surface of the abutment sealing part 260 may be exposed to the outside of the abutment sealing groove 250.

Additionally, the abutment middle hole 270 is formed in a groove structure penetrating the abutment body 210. In addition, the longitudinal axis of the abutment middle hole 270 may intersect and preferably orthogonal to the longitudinal axis of the abutment body 210. In addition, the opposite ends of the abutment middle hole 270 may open the abutment fastening hole 220.

Next, in the inserting of a reinforcement S300, a process of inserting the reinforcing part 300 into the abutment part 200 is performed. Additionally, the reinforcing part 300 may include a reinforcing body 310, a middle through hole 320, and a key protrusion part 330.

More specifically, in a sequence of FIGS. 5 and 6 illustrated, the reinforcing body 310 may be inserted into the abutment fastening hole 220. Accordingly, the lower surface of the reinforcing body 310 is in contact with the upper surface of the head part of the coupling screw 230.

Additionally, the middle through hole 320 is formed in a groove structure that penetrates the reinforcing body 310. In addition, the longitudinal axis of the middle through hole 320 may intersect and preferably be orthogonal to the longitudinal axis of the reinforcing body 310. In addition, the opposite ends of the middle through hole 320 may have open structures. Here, the middle through hole 320 may have a structure and a shape in which the middle through hole 320 may communicate correspondingly with the abutment middle hole 270.

Additionally, the key protrusion part 330 is formed by protruding from the outer circumferential surface of the reinforcing body 310. In addition, the key protrusion part 330 has a shape corresponding to the key groove 240 described above. Here, the key protrusion part 330 is inserted and guided into the key groove 240, so that the reinforcing body 310 may be inserted into the abutment fastening hole 220, and on the basis of this time, the middle through hole 320 and the abutment middle hole 270 may communicate correspondingly with each other.

That is, the formation position of the key protrusion part 330 may be determined on the basis of a state in which the middle through hole 320 and the abutment middle hole 270 are concentric with each other.

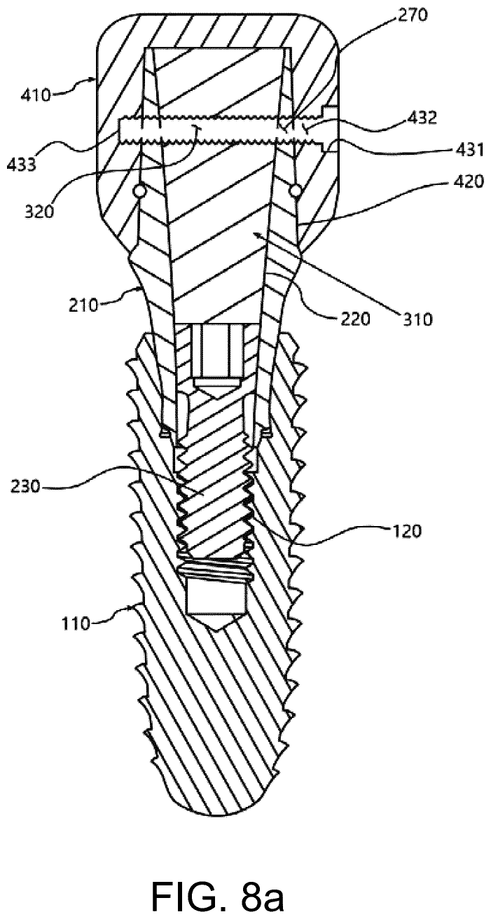

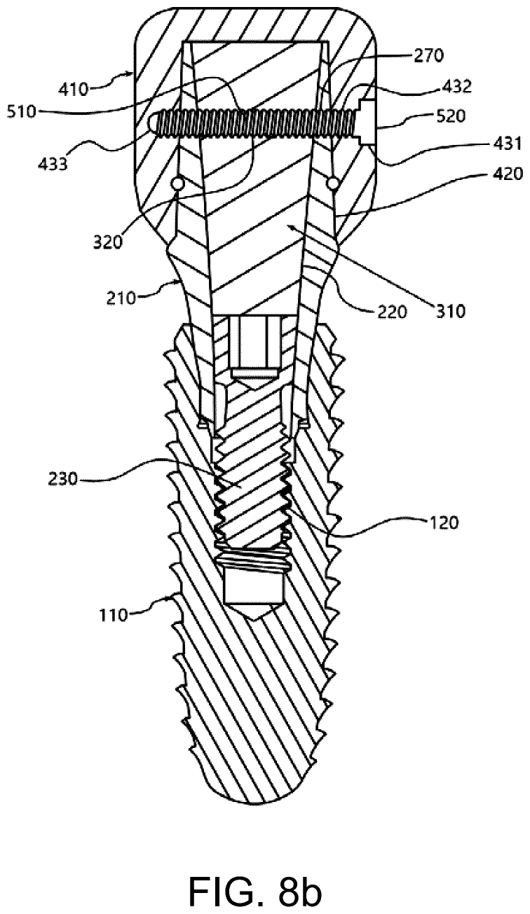

Next, FIGS. 8a and 8b are views illustrating a state in which the healing sleeve part is additionally combined in the state illustrated in FIG. 6.

Referring to FIGS. 8a and 8b, in the fastening of a healing sleeve S400, a process in which a healing sleeve is fastened to the abutment part 200 proceeds. Additionally, the healing sleeve part 400 may include a sleeve body 410, a sleeve receiving part 420, and a sleeve middle groove 430.

In detail, the sleeve body 410 may correspond to a type of healing abutment.

Additionally, the sleeve receiving part 420 is recessed upward from the lower outer surface of the sleeve body 410. Here, the upper outer surface of the abutment body 210 may be inserted into the sleeve receiving part 420 and be in surface contact with the inner surface of the sleeve receiving part 420. In this case, the sleeve receiving part 420 may have a structure corresponding to the appearance of a portion of the upper part of the abutment body 210. Accordingly, the open upper portion of the abutment body 210 is shielded by the sleeve body 410, and through this, foreign substances and various bacteria can be prevented as much as possible from penetrating into an affected part.

Additionally, as a primary procedure in a dental implant procedure, a fixture is implanted into the alveolar bone of a person who undergoes a medical procedure, and then as a secondary procedure, a healing abutment is fastened to the fixture to close the open hole of the fixture. By performing this healing abutment procedure, the healing abutment closes the open upper structure of the fixture, and through this, various bacteria and foreign substances may be prevented from entering the fixture while an adhesion process between the fixture and surrounding bone cells progresses.

After that, after adhesion between the fixture and the surrounding bone cells has sufficiently progressed, the above-mentioned healing abutment is removed, and then an abutment and a crown are finally fastened to a treatment area.

However, when the healing abutment procedure is performed in the above-described manner, various types of abutments, such as a separate healing abutment and the abutment part 200, are required to be alternately fastened to the fixture part 100 and replaced, and because of this, a person who undergoes a medical procedure requires frequent trips to a hospital and inevitably has a significant burden on the person's body due to the replacement of parts.

On the other hand, by applying the above-described healing sleeve, the abutment part 200, which is a final abutment, may be fastened directly to the fixture part 100 without the fastening of a separate healing abutment. Additionally, by shielding the open upper part of the abutment part 200, a healing abutment effect occurs that prevents the introduction of foreign substances into the fixture part 100 and the abutment part 200 while the fixture part 100 adheres to a surrounding bone tissue.

Therefore, compared to the procedure method that involves replacing a separate healing abutment and an abutment for fastening a crown, the healing sleeve part 400 described above provides a significantly advantageous effect in terms of ease of a procedure and burden on the human body.

The sleeve middle groove 430 may include a sleeve entrance groove 431, a sleeve through hole 432, and a sleeve end fixing groove 433.

More specifically, the sleeve entrance groove 431 may be formed as a recessed structure in a portion of the outer surface of the sleeve body 410 facing an opening on one side of the abutment middle hole 270 described above. In this case, the sleeve entrance groove 431 may have a structure that further extends in the radial direction of the abutment middle hole 270.

Additionally, the sleeve through hole 432 is formed through the sleeve body 410 so that the sleeve entrance groove 431 and the sleeve receiving part 420 communicate with each other. In addition, the sleeve through hole 432 may have a structure and a shape in which the sleeve through hole 432 may communicate correspondingly with the abutment middle hole 270.

Additionally, the sleeve end fixing groove 433 may be formed as a recessed structure on the inner wall surface of the sleeve receiving part 420 facing the sleeve through hole 432. In addition, the sleeve end fixing groove 433 may have a structure and a shape in which the sleeve end fixing groove 433 may communicate correspondingly with the abutment middle hole 270.

Next, in a sequence of FIGS. 8A and 8B illustrated, the fixing part 500 fixes the healing sleeve part 400. Here, the fixing part 500 may include a fixing body 510 and a fixing head 520.

More specifically, the fixing body 510 may have a diameter and a length corresponding to the abutment middle hole 270, the middle through hole 320, the sleeve through hole 432, and the sleeve end fixing groove 433 described above. Here, a predetermined thread structure is formed on the outer peripheral surface of the fixing body 510, so that the fixing body 510 may have a type of screw structure. In addition, to engage the screw thread structure of the fixing body 510, a corresponding screw groove structure may be formed in each of the abutment middle hole 270, the middle through hole 320, the sleeve through hole 432, and the sleeve end fixing groove 433.

Additionally, the fixing head 520 is formed on one end of the fixing body 510 and may be provided in the sleeve entrance groove 431. In addition, the fixing head 520 may have a structure that extends in a radially outward direction of the fixing body 510. In addition, the fixing head 520 may have a diameter and a shape corresponding to the minimum diameter of the sleeve entrance groove 431 described above.

Accordingly, on the basis of a state in which the fixing body 510 is completely fastened to the healing sleeve part 400, the abutment part 200, and the reinforcing part 300, the end surface of the fixing head 520 on the side of the fixing body 510 is in surface contact with the outer surface of the entrance end of the sleeve through hole 432. In addition, the edge surface of the fixing head 520 is in surface contact with the inner circumferential surface of the sleeve entrance groove 431.

That is, the fixing part 500 is fastened through the sleeve middle groove 430, the abutment middle hole 270, and the middle through hole 320, thereby fixing the coupled state of the healing sleeve part 400, the abutment part 200, and the reinforcing part 300.

Here, the reinforcing part 300 described above may be provided to be compressed by the upper outer surface of the coupling screw 230 and the upper inner surface of the healing sleeve part 400. To this end, the length of the reinforcing part 300 may be greater than a distance between the upper outer surface of the coupling screw 230 and the upper inner surface of the healing sleeve part 400, and when manufacturing the reinforcing part 300, a predetermined elastic material may be used.

Through the compression structure using the size difference described above, an elastic restoration in which the length of the reinforcing part 300 extends in a vertical direction occurs in the reinforcing part 300. In addition, the direction of this elastic restoration is a direction in which the reinforcing part 300 is in close contact with the healing sleeve part 400 and the coupling screw 230, and as a result, the reinforcing part 300 continues to be in close contact with the healing sleeve part 400 and the coupling screw 230, thereby improving the internal airtightness of the implant.

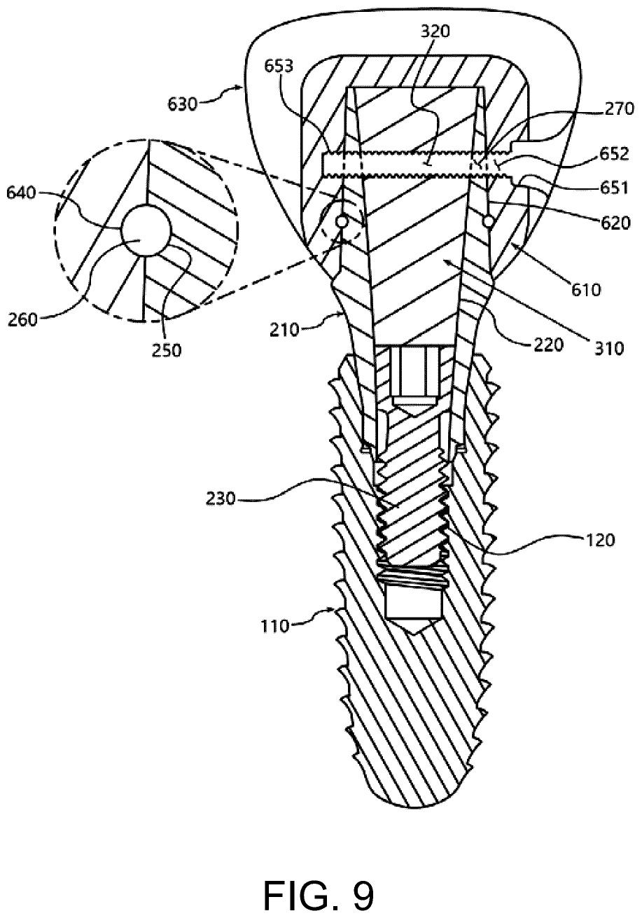

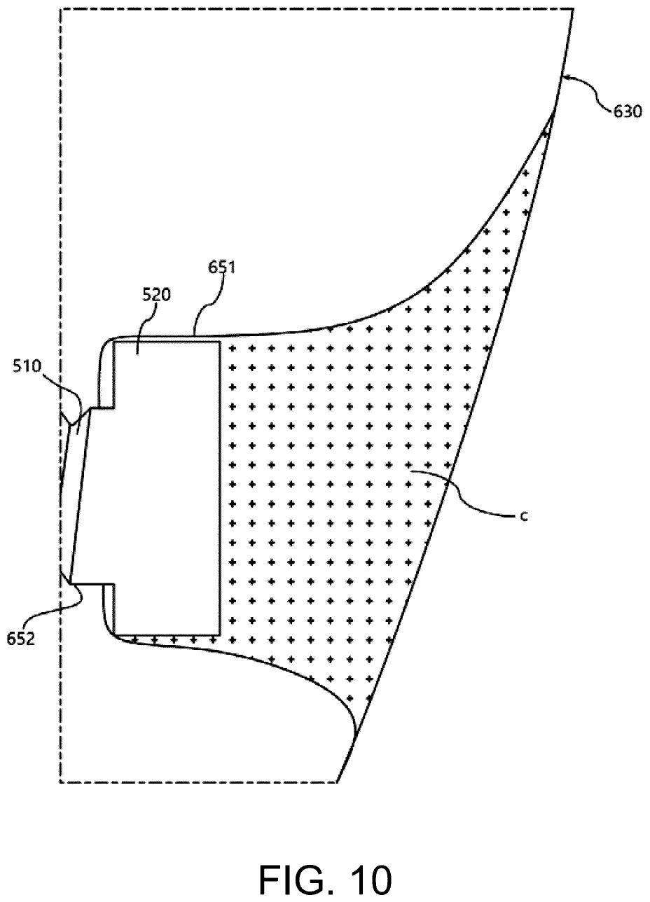

Next, FIG. 9 is a view illustrating a state in which the crown part is additionally combined in the state illustrated in FIG. 6, and FIG. 10 is a view illustrating a state in which a filling member filled in an entrance groove illustrated in FIG. 3.

Referring to FIGS. 9 and 10, in the fastening of a crown S500, as a final process in the implant procedure, the crown part 600 may be fastened to the abutment part 200. Here, the crown part 600 may include a crown internal shape part 610, a crown receiving part 620, a crown body 630, a crown sealing groove 640, and a crown middle groove 650.

First, to perform the fastening of a crown S500, in a sequence of FIGS. 8B, 8A, and 6 illustrated, the fixing part 500 and the healing sleeve part 400 are separated from each other. Accordingly, as illustrated in FIG. 6, in an entire implant structure, only the fixture part 100, the abutment part 200, and the reinforcing part 300 are maintained to be coupled to each other. Here, the healing sleeve separation process described above may be performed after adhesion between the fixture part and a surrounding bone tissue has sufficiently progressed.

Next, the implant procedure is completed by combining the crown part 600 and the fixing part 500 with other implant structures.

More specifically, the crown receiving part 620 is recessed upward from the lower outer surface of the crown internal shape part 610 so that the crown internal shape part 610 covers a portion of the upper outer surface of the abutment body 210. In addition, the crown receiving part 620 may have a shape corresponding to the sleeve receiving part 420 described above.

Here, to determine the shape structure of the crown receiving part 620, an impression taking process based on the healing sleeve part 400 used previously may be performed. In addition, for this impression taking process, a separate impression material may be used, and a type of digital abutment process such as an oral scan may be performed. In this case, a separate marker (not shown) may be applied to the healing sleeve part 400 to perform a digital impression taking process.

Next, on the basis of an impression taking result, a mold (not shown) with a recessed structure corresponding to the sleeve receiving part 420 may be manufactured. Additionally, a casting process may be performed on the basis of this mold (not shown) so that the crown internal shape part 610 may be formed. In the above-described casting process, the crown internal shape part 610 may be manufactured by melting the sleeve body 410 and then mixing the melted sleeve body 410 with other materials.

Additionally, the crown body 630, which is a type of tooth-shaped prosthesis, is provided to cover the outer surface of the crown internal shape part 610. In addition, the crown body 630 and the crown internal shape part 610 may be formed integrally with each other.

Next, in a sequence of FIGS. 6 and 9 illustrated, the upper outer surface of the abutment body 210 may be inserted into the crown receiving part 620 and may be in surface contact with the inner surface of the crown receiving part 620.

Here, like the healing sleeve part 400 described above, a distance between the upper inner surface of the crown body 630 and the upper outer surface of the coupling screw 230 may be smaller than the length of the reinforcing part 300. Accordingly, the elastic restoration and sealing of the reinforcing part 300 provided between the healing sleeve part 400 and the coupling screw 230 also occurs between the crown body 630 and the coupling screw 230.

Additionally, the crown sealing groove 640 is formed in a recessed structure along the circumferential direction of the inner wall surface of the crown receiving part 620. In addition, the crown sealing groove 640 may face the abutment sealing groove 250 described above. Accordingly, the remaining outer surface of the abutment sealing part 260 exposed to the outside of the abutment sealing groove 250 is in surface contact with the crown sealing groove 640.

Here, the thickness of the abutment sealing part 260 may be provided to be compressed by the abutment sealing groove 250 and the crown sealing groove 640. Accordingly, a continuous elastic restoring force is applied to the abutment sealing part 260 in a direction toward each of the abutment sealing groove 250 and the crown sealing groove 640. Through this elastic restoring force, the abutment sealing part 260 continues to adhere closely to the abutment sealing groove 250 and the crown sealing groove 640, and through this, airtightness between the crown part 600 and the abutment part 200 may be increased.

Additionally, the crown middle groove 650 may include a crown entrance groove 651, a crown through hole 652, and a crown end fixing groove 653.

More specifically, the crown entrance groove 651 may be formed as a recessed structure in a portion of the outer surface of the crown body 630 facing the opening on one side of the abutment middle hole 270 described above. In this case, the crown entrance groove 651 may have a structure that further extends in the radial direction of the abutment middle hole 270. That is, the crown entrance groove 651 has a structure corresponding to the sleeve entrance groove 431 described above.

Additionally, by corresponding to the sleeve through hole 432 described above, the crown through hole 652 is formed through the crown body 630 so that the crown entrance groove 651 and the crown receiving part 620 communicate with each other. In addition, the crown through hole 652 may have a structure and a shape in which the crown through hole 652 can communicate correspondingly with the abutment middle hole 270.

Additionally, by corresponding to the sleeve end fixing groove 433 described above, the crown end fixing groove 653 may be formed as a recessed structure on the inner wall surface of the crown receiving part 620 facing the crown through hole 652. In addition, the crown end fixing groove 653 may have a structure and a shape in which the crown end fixing groove 653 can communicate correspondingly with the abutment middle hole 270.

Next, like the fastening process of the fixing part 500 described above, the fixing body 510 passes through and fastened to the crown entrance groove 651, the crown through hole 652, the abutment middle hole, and the crown end fixing groove 653 along the longitudinal direction thereof as described above in a sequence of FIGS. 9 and 3, and thus the position of the crown part 600 may be completely fixed. Here, the end surface of the fixing head 520 on the side of the fixing body 510 is in surface contact with the outer surface of the entrance end of the crown through hole 652. In addition, the edge surface of the fixing head 520 is in surface contact with the inner circumferential surface of the crown entrance groove 651.

That is, the fixing part 500 is used to fix the healing sleeve part 400 and the crown part 600, which shield an upper opening in the coupled structure of the fixture part 100 and the abutment part 200, and to enable the fixing part 500 to be fastened, the sleeve middle groove 430 and the crown middle groove 650 are formed in the healing sleeve part 400 and the crown part 600, respectively.

Additionally, referring to FIG. 10, after the coupling of the fixing part 500 described above, a filling member c may be filled inside the crown entrance groove 651 as a finishing process. By performing this final filling process, the introduction of foreign substances that may occur along the movement line of the fixing part 500 may be prevented.

In this case, as a detailed option for the filling member c, resin, amalgam, various other dental filling materials or cements not mentioned, and adhesives, etc. may be used.

Here, when considering the longitudinal axis direction of the fixing part 500 described above, the outer surface of the filling member c exposed to the outside is located in a direction that intersects a chewing surface on the upper outer surface of the crown part 600, and accordingly, the outer surface of filling member c is not directly exposed to the chewing activity of the oral cavity.

In addition, the filling member c is used only in the recessed section corresponding to the crown entrance groove 651 and occupies an extremely small volume and area compared to the overall shape of the crown part 600, thereby facilitating the removal of the crown part 600 when replacing the crown part 600 in the future, and minimizing impacts thereof on surrounding parts and oral structures.

In addition, in order to minimize interference with adjacent teeth when attaching and detaching the fixing part 500, the crown entrance groove 651 described above may be formed in a direction that intersects with a tooth arrangement direction (a mesial surface of molars) such as the front (Buccal) side or rear (Lingual) side of the teeth. In addition, preferably, the crown entrance groove 651 may be formed on the rear (Lingual) side of the tooth so that a hole structure, etc. is not exposed to the outside for beauty.

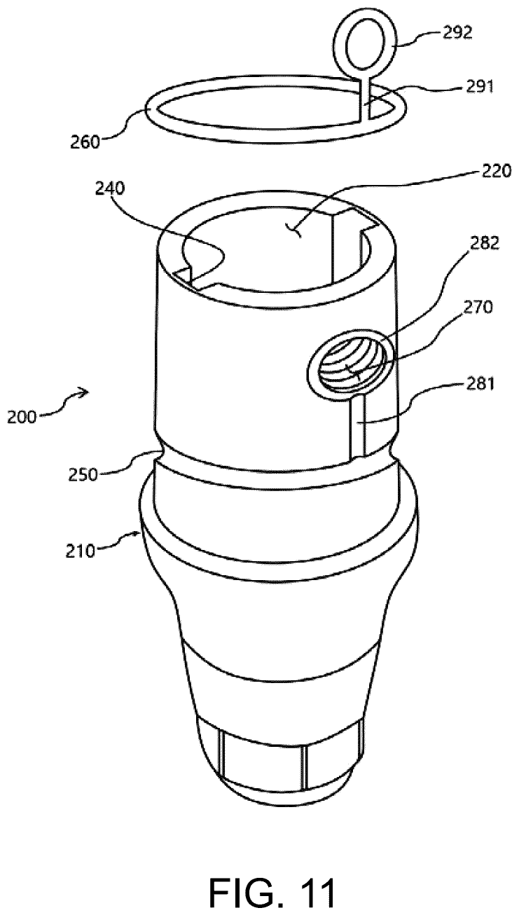

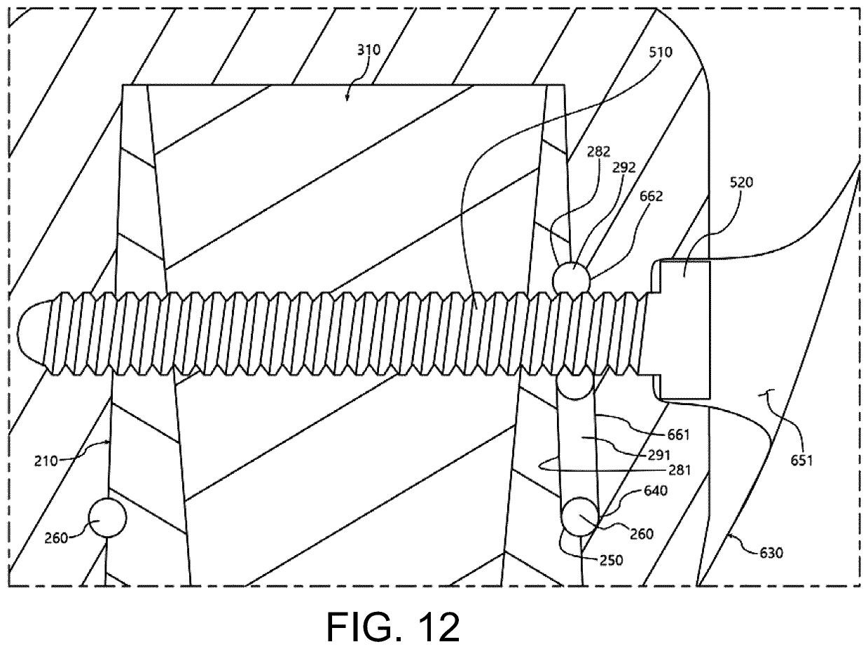

Next, FIG. 11 is an exploded perspective view illustrating an abutment part according to a second embodiment of the present disclosure, and FIG. 12 is a cross-sectional view illustrating the embodiment of the abutment part illustrated in FIG. 10.

Referring to FIGS. 11 and 12, the abutment part 200 described above may further include an extension sealing groove 281, a fixing side sealing groove 282, an extension sealing part 291, and a fixing side sealing part 292.

The extension sealing groove 281 has a structure recessed from the abutment sealing groove 250 described above and extends upward along the longitudinal direction of the abutment body 210. In addition, the extension sealing groove 281 may be provided in a straight structure with the shortest movement line toward the entrance of the abutment middle hole 270 provided at the side of the fixing head 520.

Additionally, the fixing side sealing groove 282 may be formed as a structure recessed along the entrance edge of the abutment middle hole 270 provided at the side of the fixing head 520. In addition, the fixing side sealing groove 282 may have a structure in communication with the extension sealing groove 281.

That is, the abutment sealing groove 250 described above is formed along the circumferential direction of the outer surface of the abutment body 210, the fixing side sealing groove 282 is formed on the entrance edge of the abutment middle hole 270 relative to the insertion direction of the fixing part 500, and the abutment sealing groove 250 and the fixing side sealing groove 282 communicate with each other by the extension sealing groove 281.

Additionally, one end of the extension sealing part 291 is connected to the abutment sealing part 260 described above. In addition, the extension sealing part 291 is formed in a straight structure corresponding to the extension sealing groove 281 described above.

Additionally, the fixing side sealing part 292 is connected to an end of the extension sealing part 291 and has a type of O-ring structure. In addition, the fixing side sealing part 292 has a shape corresponding to the fixing side sealing groove 282 described above.

That is, the abutment sealing part 260, the extension sealing part 291 and the fixing side sealing part 292 has an integrated packing structure that can be custom-fitted into an integrated groove structure such as the abutment sealing groove 250, the extension sealing groove 281 and the fixing side sealing groove 282. In addition, the above-described integrated packing structure may be manufactured of the same type of elastic material.

Additionally, a crown sealing extension groove 661 having a structure corresponding to the extension sealing groove 281 is recessed on the inner wall surface of the crown receiving part 620 facing the extension sealing groove 281. In addition, a crown through hole packing groove 662 having a structure corresponding to the fixing side sealing groove 282 is recessed on the inner wall surface of the crown receiving part 620 facing the fixing side sealing groove 282.

In addition, the thickness of the extension sealing part 291 may be larger than a diameter between the extension sealing groove 281 and the crown sealing extension groove 661. Accordingly, the extension sealing part 291 is compressively deformed by the extension sealing groove 281 and the crown sealing extension groove 661, and then is elastically restored in a direction in close contact with each of the extension sealing groove 281 and the crown sealing extension groove 661.

In addition, the thickness of the fixing side sealing part 292 may be larger than a diameter between the fixing side sealing groove 282 and the crown through hole packing groove 662. Accordingly, the fixing side sealing part 292 is compressively deformed by the fixing side sealing groove 282 and the crown through hole packing groove 662, and then is elastically restored in a direction in close contact with each of the fixing side sealing groove 282 and the crown through hole packing groove 662.

In addition, the minimum inner diameter of the fixing side sealing part 292 may be smaller than the minimum outer diameter of the fixing body 510. Accordingly, when the fixing part 500 is fastened, the inner circumferential surface of the fixing side sealing part 292 is pressed by the fixing body 510 and elastically deformed in a direction in which the inner diameter of the fixing side sealing part 292 increases, and then again is elastically restored in a direction of close contact with the fixing body 510, which is a direction in which the inner diameter decreases.

As the elastic restoration of the fixing side sealing part 292 described above progresses, significant airtightness is provided to the edge of the outer surface of the fixing body 510 on the side of the crown entrance groove 651, and accordingly, the introduction of foreign substances into an implant through an opening on the side of the crown entrance groove 651 may be further prevented.

In addition, the abutment sealing part 260 and the fixing side sealing part 292, which pack different parts, are integrally connected to each other by the extension sealing part 291, and by providing a packing fastening groove structure that takes into account the integrated packing structure described above, such as the extension sealing part 291 and the crown sealing extension groove 661, the convenience of a procedure may be further improved.

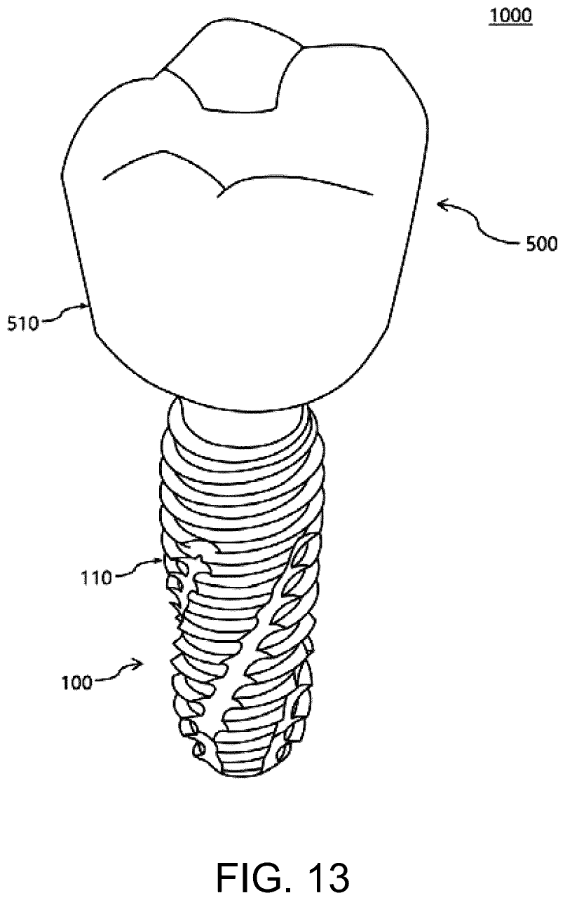

FIG. 13 is a perspective view illustrating a dental implant according to a third embodiment of the present disclosure.

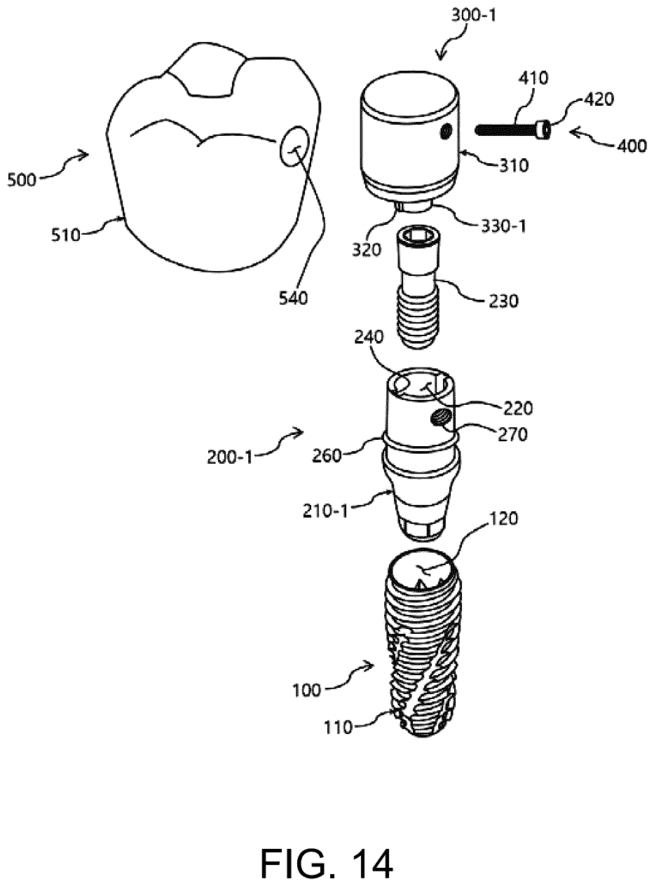

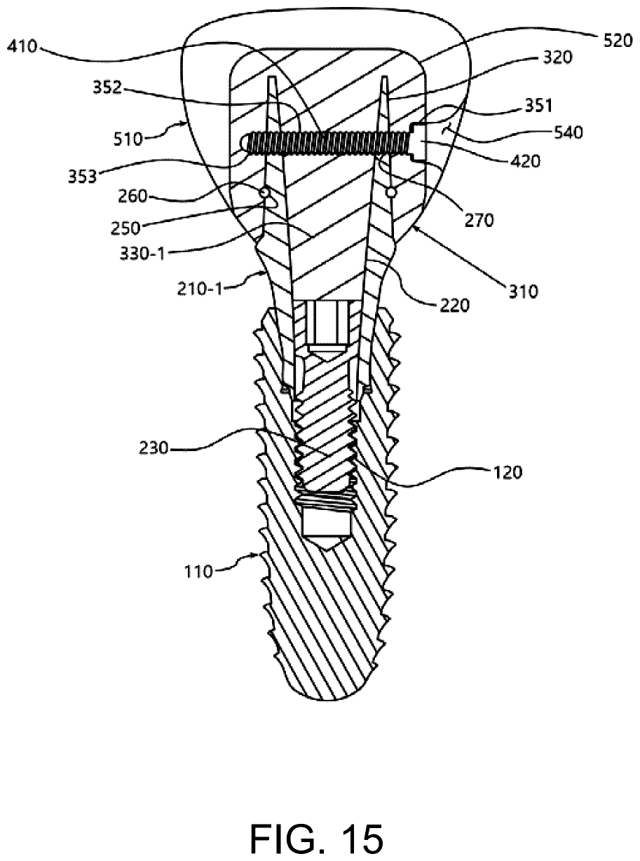

Additionally, FIG. 14 is an exploded perspective view of FIG. 13, and FIG. 15 is a front cross-sectional view of FIG. 13.

Referring to FIGS. 13 to 15, the dental implant 1000 according to a third embodiment of the present disclosure includes the fixture part 100, an abutment part 200-1, a healing sleeve part 300-1, a fixing part 400, and a crown part 500.

In addition, the fixture part 100 includes the fixture body 110 and the fixture screw groove 120.

More specifically, the fixture body 110 has a type of screw structure with a predetermined thread structure formed along the longitudinal direction of the outer circumferential surface thereof, and corresponds to the fixture of the dental implant. In addition, the fixture body 110 may be implanted by penetrating the alveolar bone area of a person who undergoes a medical procedure by using various dental tools not shown, such as a dental driver.

Additionally, the fixture screw groove 120 is formed as a groove structure depressed downward along the longitudinal direction of the fixture body 110 from the upper outer surface of the fixture body 110.

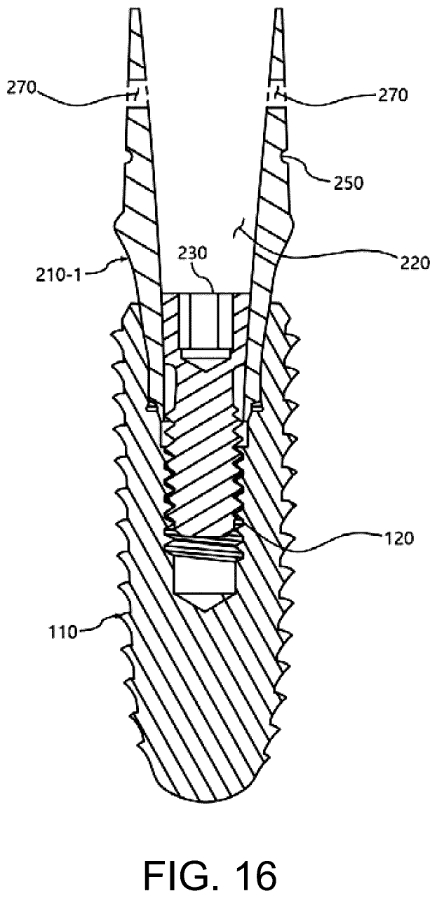

Next, FIG. 16 is a view illustrating the coupled state of the fixture part and the abutment part illustrated in FIG. 15.

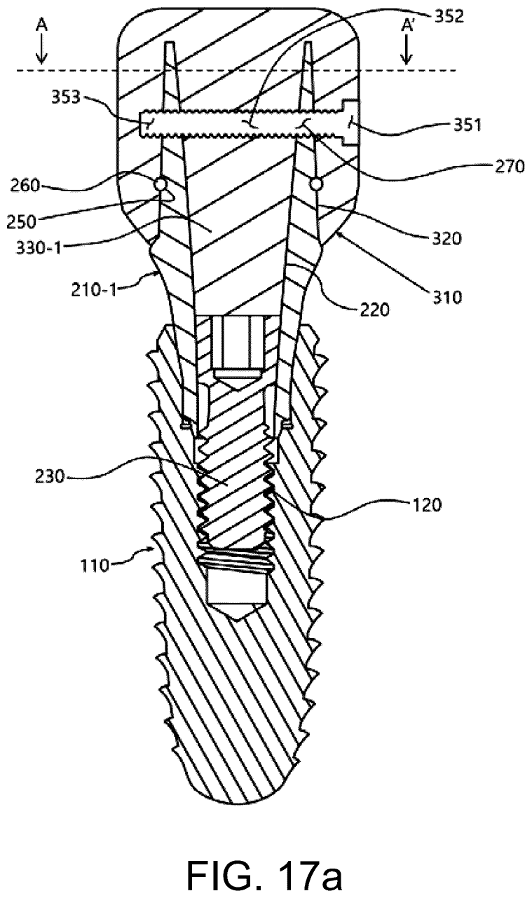

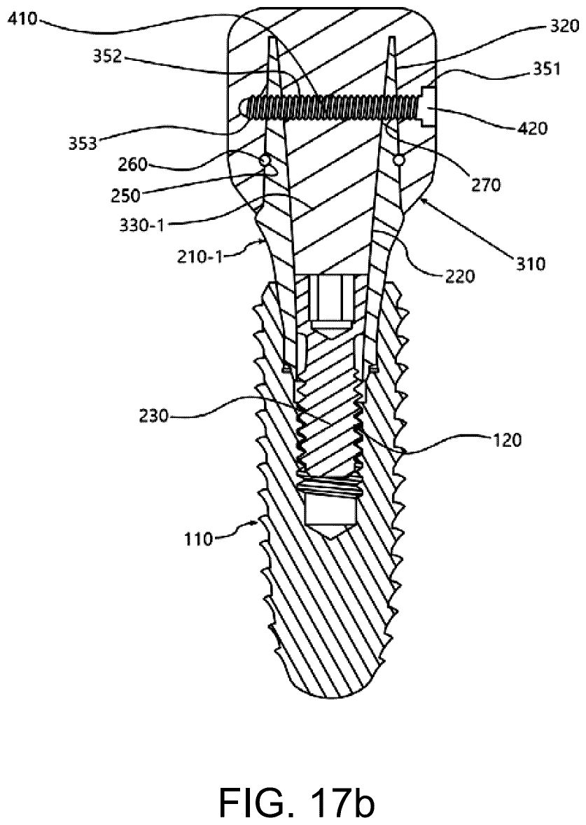

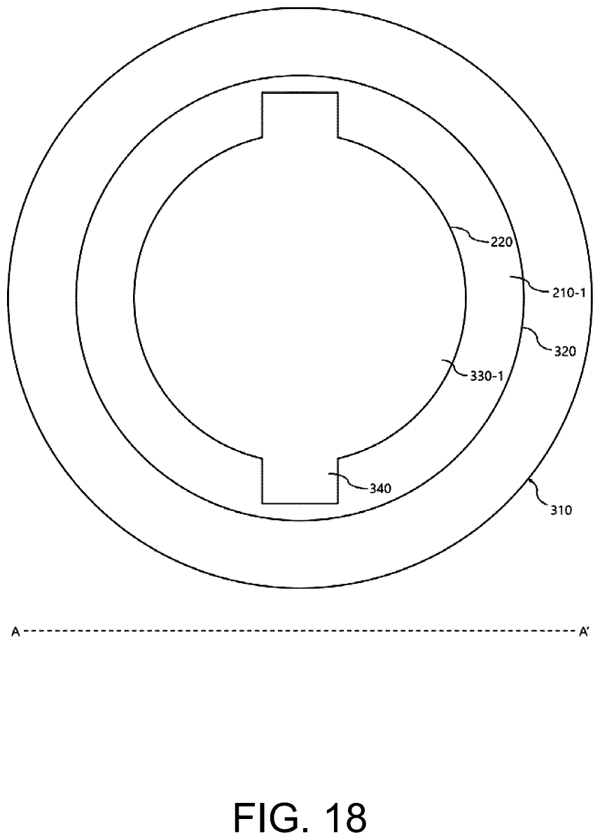

Additionally, FIGS. 17a and 17b are views illustrating a state in which the healing sleeve part is additionally combined in the state illustrated in FIG. 16. Additionally, FIG. 18 is a cross-sectional view relative to a state viewed from A-A′ illustrated in FIG. 17a.

Referring to FIGS. 16, 17a, 17b, and 18, after the fixture procedure for the fixture part 100 is completed, an abutment procedure in which the abutment part 200-1 is assembled and combined with the fixture part 100 may be performed. In addition, the abutment part 200-1 may include the abutment body 210-1, the abutment fastening hole 220, the coupling screw 230, the key groove 240, the abutment sealing groove 250, the abutment sealing part 260, and an abutment middle groove 270.

More specifically, the abutment body 210-1 has an appearance that corresponds to an abutment in the dental implant. In addition, the abutment body 210-1 may be inserted into and accommodated inside the fixture screw groove 120 from the lower end of the abutment body 210-1 to a predetermined height position thereof.

Additionally, the abutment fastening hole 220 is formed in a hole structure along the longitudinal direction of the abutment body 210-1 while the upper and lower outer surfaces of the abutment body 210-1 are open.

Additionally, after the coupling screw 230 is inserted into the upper opening of the abutment fastening hole 220 and moves downward, an end of the coupling screw 230 is inserted into the fixture screw groove 120. In addition, the thread structure corresponding to the screw groove structure of the fixture screw groove 120 is formed on the outer circumferential surface of the coupling screw 230. Through the engagement of the screw groove structure with the thread structure, the coupled state of the fixture part 100 with the abutment part 200-1 may be securely fixed.

Additionally, the head part of the coupling screw 230 is formed to have a larger diameter than the threaded body. In addition, on the basis of a state in which the screw coupling of the coupling screw 230 and the fixture part 100 is completed, the diameter of a position in the abutment fastening hole 220 corresponding to the head part of the coupling screw 230 may correspond to the diameter of the head part of the coupling screw 230.

In addition, a kind of stepped structure protruding along the diameter of the abutment fastening hole 220 may be formed on a lower end thereof, and the diameter of the stepped structure corresponds to the diameter of the threaded body of the coupling screw 230. In this case, the diameter of the threaded body of the coupling screw 230 is smaller than the head part thereof.

Accordingly, when the coupling screw 230 moves downward, the head part of the coupling screw 230 is spatially interfered with the step structure on the lower end of the abutment body 210-1 described above. In this case, even if an external force is applied in the direction of separating the fixture part 100 and the abutment part 200-1 from each other, the lower surface of the head part of the coupling screw 230 is blocked by the upper surface of the step of the abutment fastening hole 220, and accordingly, even if the screw structure of the fixture screw groove 120 or the coupling screw 230 is worn, the coupling of the fixture part 100 and the abutment part 200-1 can be securely maintained due to the action of the step described above.

Additionally, the key groove 240 has a structure protruding from the inner side of the upper open surface edge of the abutment fastening hole 220 in the radially outward direction of the abutment fastening hole 220. In addition, the key groove 240 may have a predetermined length and extend downward. In addition, the key groove 240 may include a plurality of key grooves formed along the circumferential direction of the abutment fastening hole 220.

Additionally, the abutment sealing groove 250 is formed in a recessed structure along the circumferential direction of the outer circumferential surface of the abutment body 210-1.

Additionally, the abutment sealing part 260 is formed in a type of O-ring structure and is fastened to the abutment sealing groove 250. In this case, the abutment sealing part 260 may be formed to be exposed to the outside of the outer surface of the abutment body 210-1.

Additionally, the abutment middle groove 270 is formed in a structure of two grooves penetrating the abutment body 210-1, and may be located at a point spaced upward by a predetermined distance or more away from the upper opening of the fixture part 100. In addition, the longitudinal axis of the abutment middle groove 270 may intersect and preferably be orthogonal to the longitudinal axis of the abutment body 210-1. In addition, the opposite ends of the abutment middle hole may open the abutment fastening hole 220.

Next, in a sequence of FIGS. 17a and 16 illustrated, after an abutment procedure for the abutment part 200-1 is completed, a type of healing abutment procedure in which the healing sleeve part 300-1 is assembled and combined with the abutment part 200-1 may be performed.

In addition, the healing sleeve part 300-1 may include a sleeve body 310, a sleeve receiving part 320, an internal insertion part 330-1, a key protrusion part 340, a sleeve entrance groove 351, a sleeve through groove 352, and a sleeve end groove 353.

More specifically, the sleeve body 310 corresponds to a type of healing abutment and performs the function of preventing foreign substances from entering an affected part by closing the periphery of the fixture part 100 during the middle process of an implant procedure. Here, according to the present disclosure, after the implantation of the fixture part 100, the abutment part 200-1 is immediately coupled thereto, and thus the sleeve body 310 is provided to close the upper opening of the abutment part 200-1.

Additionally, the sleeve receiving part 320 is recessed upward from the lower outer surface of the sleeve body 310. Here, the upper outer surface of the abutment body 210-1 may be inserted into the sleeve receiving part 320 and be in surface contact with the inner surface of the sleeve receiving part 320. In this case, the sleeve receiving part 320 may have a structure corresponding to the appearance of a portion of the upper part of the abutment body 210-1. Accordingly, the open upper side of the abutment body 210-1 is shielded by the sleeve body 310, and through this, foreign substances and various bacteria may be prevented as much as possible from penetrating into an affected area.

Additionally, inside the sleeve receiving part 320, the internal insertion part 330-1 is formed in a structure protruding downward from the upper ceiling surface of the sleeve receiving part 320. In addition, the internal insertion part 330-1 is formed to correspond to the abutment fastening hole 220.

Additionally, the key protrusion part 340 extends from the outer surface of the internal insertion part 330-1 and is formed to correspond to the key groove 240. In this case, the internal insertion part 330-1 and the key protrusion part 340 may be provided by corresponding to the coupled form of the abutment fastening hole 220 and the key groove 240.

Here, when the healing sleeve part 300-1 moves downward after the lower surfaces of the internal insertion part 330-1 and the key protrusion part 340 are arranged to face the upper opening surfaces of the abutment fastening hole 220 and the key groove 240, the healing sleeve part 300-1 may be assembled to close the upper opening of the abutment part 200-1 and simultaneously cover the abutment part 200-1. In this case, at least a lower surface of the internal insertion part 330-1 is provided to elastically press the upper surface of the head part of the coupling screw 230 downward, thereby securely maintaining the screw coupling of the coupling screw 230 and the fixture part 100 and improving internal airtightness.

Additionally, the sleeve entrance groove 351 may be formed as a through groove structure in a portion on the outer surface of the sleeve body 310 facing the opening on the one side of the abutment middle groove 270 described above. Accordingly, the opening on the one side of the abutment middle groove 270 and the sleeve entrance groove 351 may communicate with each other.

Additionally, the sleeve through groove 352 may be formed through the internal insertion part 330-1 so as to be coaxial with the sleeve entrance groove 351 and the abutment middle groove 270.

Additionally, the sleeve end groove 353 may be formed as a recessed structure on the inner wall surface of the sleeve receiving part 320 facing coaxially with the sleeve through groove 352.

Accordingly, in the coupled structure of the healing sleeve part 300-1 and the abutment part 200-1, a groove structure in which the sleeve entrance groove 351, a first side of the abutment middle groove 270, the sleeve through groove 352, a second end of the abutment middle groove 270, and the sleeve end groove 353 are provided coaxially with each other is formed. Here, the sleeve entrance groove 351 is open to the outside, and the end of the sleeve end groove 353 is not open to the outside.

In addition, the sleeve through groove 352, the abutment middle groove 270, and the sleeve end groove 353 may have diameters corresponding to each other, and predetermined screw groove structures may be formed along longitudinal directions thereof. In addition, the sleeve entrance groove 351 may have a larger diameter than the abutment middle groove 270, the sleeve through groove 352, and the sleeve end groove 353, and may be formed as a structure corresponding to a type of screw head shape.

Next, in a sequence shown in FIGS. 17a and 17b, the fixing part 400 fixes the coupling of the healing sleeve part 300-1 and the abutment part 200-1 through a screw coupling method. In addition, the fixing part 400 may include a fixing body 410 and a fixing head 420.

More specifically, the fixing body 410 may have a diameter and a length corresponding to the sleeve through groove 352, the abutment middle groove 270, and the sleeve end groove 353, and may have a thread structure formed on an outer circumferential surface thereof to have a type of screw structure.

Additionally, the fixing head 420 is formed on one end of the fixing body 410 and may be formed as a type of screw head structure with a size and a structure corresponding to the sleeve entrance groove 351.

Accordingly, another end of the fixing body 410 is provided in the sleeve end groove 353, and the remaining length thereof is provided in the abutment middle groove 270 and the sleeve through groove 352. Additionally, the fixing head 420 is provided in the sleeve entrance groove 351.

In this case, on the basis of a state in which the key protrusion part 340 is inserted into the key groove 240, the coaxial arrangement structure of the sleeve entrance groove 351, the sleeve through groove 352, the abutment middle groove 270, and the sleeve end groove 353 may be determined. That is, the key groove 240 and the key protrusion part 340 serve to guide the easy implementation of the coaxial arrangement of the sleeve entrance groove 351, the sleeve through groove 352, the abutment middle groove 270, and the sleeve end groove 353 can be easily implemented.

Afterwards, a state in which the abutment part 200-1 and the healing sleeve part 300-1 are coupled to each other by the fixing part 400 may be maintained for a period of time corresponding to a medical professional's diagnosis.

In addition, on the basis of the state in which the healing sleeve part 300-1 is fastened, a kind of digital impression taking process such as an oral scan may be performed, and the shape of the crown part 500, which will be fastened later, may be designed and manufactured on the basis of this impression taking data.

In addition, in order to identify relative position and distance between the healing sleeve part 300-1 and the surrounding intraoral structures during the impression taking process, a separate identification marker, which is not shown, may be provided on the healing sleeve part 300-1, or a separate protruding or recessed structure, and an inclined structure, etc. may be additionally formed for such an identification function.

After the crown design and manufacturing process based on the above-described impression taking data is completed, the fixing part 400 is removed, and a coupling structure between implant parts is prepared again in a state corresponding to FIG. 17a.

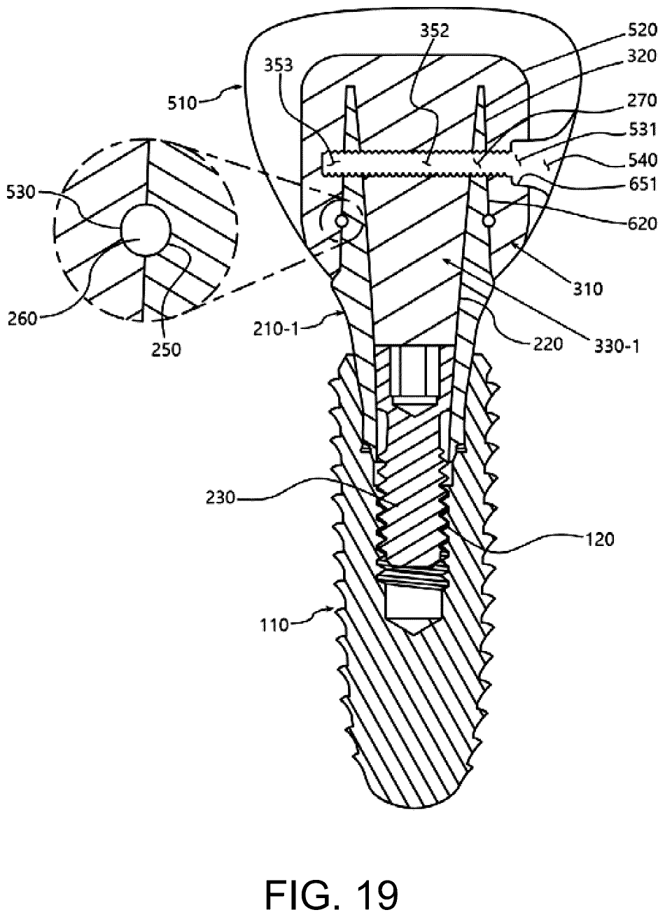

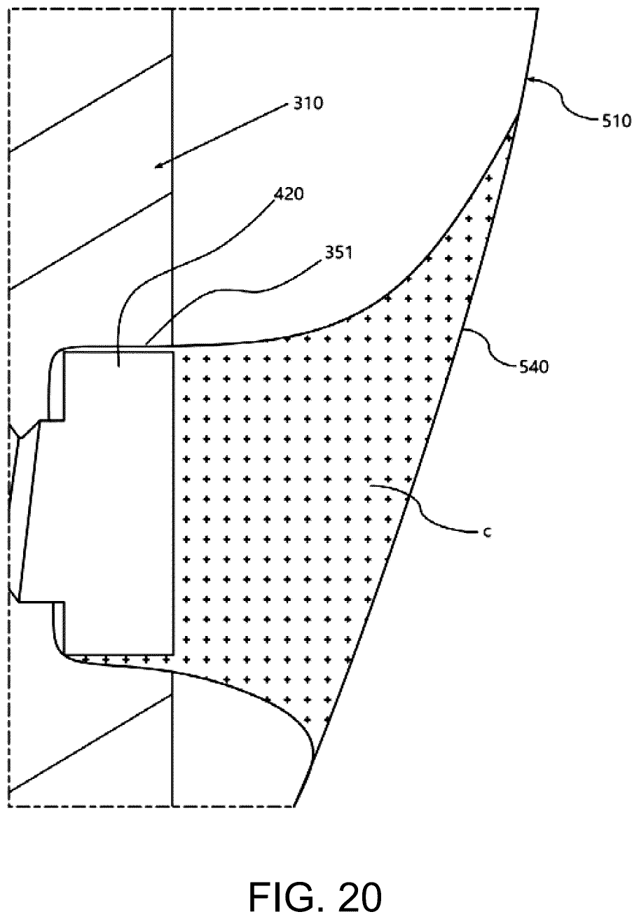

Next, FIG. 19 is a view illustrating a state in which the crown part is additionally combined in the state illustrated in FIG. 17a. Additionally, FIG. 20 is a view illustrating a state in which the filling member is filled in the crown entrance groove illustrated in FIG. 15.

Next, in a sequence illustrated in FIGS. 17a to 19, the crown part 500, which is designed and manufactured through the impression taking process, is prepared to cover the outer circumference of the healing sleeve part 300-1. In addition, the crown part 500 may include a crown body 510, a crown receiving part 520, a crown sealing groove 530, and a crown entrance groove 540.

More specifically, the crown body 510 is a type of tooth-shaped prosthesis designed and manufactured through the above-mentioned impression taking process, taking into consideration the type of a tooth missing at a corresponding location and natural arrangement thereof with the surrounding oral structure.

Additionally, the crown receiving part 520 is recessed upward from the lower outer surface of the crown body 510 toward the top. In addition, the crown receiving part 520 has a shape corresponding to the external shape of the healing sleeve part 300-1 and is formed to be in surface contact with the upper surface and peripheral surface of the healing sleeve part 300-1.

Here, as described above, as a protruding or recessed structure, and an inclined structure, etc. are additionally formed on the external shape of the healing sleeve part 300-1, the healing sleeve part 300-1 may be formed asymmetrically relative to a height direction thereof. Additionally, by using a specific part of this asymmetric structure as an identification element for the surrounding oral structure, all designs, including the appearance and arrangement direction of the crown part 500, may be performed. In this case, the appearance and arrangement direction of the crown body 510 may be determined on the basis of a state in which the crown receiving part 520 is in surface contact with and covers the healing sleeve part 300-1.

That is, each of the healing sleeve part 300-1 and the crown receiving part 520 has an asymmetric structure in the height or length direction thereof and thus does not rotate along a peripheral direction thereof during mutual insertion and coupling process thereof, and on the basis of the state in which both of the components are accurately engaged with each other, the appearance of the crown body 510, which considers arrangement thereof with the surrounding oral structures, is determined.

In this way, as the above-mentioned asymmetric structure is provided to prevent the crown part 500 from being rotated to a wrong position, the accuracy and convenience of a procedure may be improved.

Additionally, the crown sealing groove 530 is formed in a recessed structure along the peripheral direction of the inner wall surface of the crown receiving part 520. In addition, the crown sealing groove 530 may face the abutment sealing groove 250 described above. Accordingly, the remaining outer surface portion of the abutment sealing part 260 exposed to the outside of the abutment sealing groove 250 is in surface contact with the crown sealing groove 530.

Here, the thickness of the abutment sealing part 260 may be provided such that the abutment sealing part 260 can be compressed by the abutment sealing groove

250 and the crown sealing groove 530. Accordingly, a continuous elastic restoring force is applied to the abutment sealing part 260 in a direction toward each of the abutment sealing groove 250 and the crown sealing groove 530. Through this elastic restoring force, the abutment sealing part 260 continues to adhere closely to the abutment sealing groove 250 and the crown sealing groove 530, and through this, airtightness between the crown part 500 and the abutment part 200-1 may be increased.

Additionally, the crown entrance groove 540 may be formed as a structure penetrating a portion of the outer surface of the crown body 510 facing the sleeve entrance groove 351. In addition, the area of the opening of the crown entrance groove 540 may gradually increase toward the outer surface of the crown body 510.

Next, as in a sequence of FIGS. 19 to 15 illustrated, the fixing part 400 is inserted through the crown entrance groove 540 in a manner corresponding to the sequence of FIGS. 17A and 17B illustrated, and thus the coupled state of the crown part 500, the healing sleeve part 300-1, and the abutment part 200-1 may be fixed.

In addition, referring to FIG. 20, after the coupling of the fixing part 400 described above, the filling member c may be filled inside the crown entrance groove 540 as a finishing process. By performing this final filling process, the introduction of foreign substances that may occur along the movement line of the fixing part 400 may be prevented.

In this case, as a detailed option for the filling member c, resin, amalgam, various other dental filling materials or cements not mentioned, and adhesives, etc. may be used.

Here, when considering the longitudinal axis direction of the fixing part 400 described above, the outer surface of the filling member c exposed to the outside is located in a direction that intersects the height direction of a chewing surface, which is the upper outer surface of the crown part 500, and accordingly, the outer surface of the filling member c is not directly exposed to the chewing activity of the oral cavity.

In addition, the filling member c is used only in the recessed section corresponding to the crown entrance groove 540 and occupies an extremely small volume and area compared to the overall shape of the crown part 500, thereby facilitating the removal of the crown part 500 when replacing the crown part 500 in the future, and minimizing impacts thereof on surrounding parts and oral structures.

In addition, in order to minimize interference with adjacent teeth when attaching and detaching the fixing part 400, the crown entrance groove 540 described above may be formed in a direction that intersects with a tooth arrangement direction (a mesial surface of molars) such as the front (buccal) side or rear (lingual) side of the teeth. In addition, preferably, the crown entrance groove 540 may be formed on the rear (lingual) side of the tooth so that a hole structure, etc. is not exposed to the outside for aesthetics.

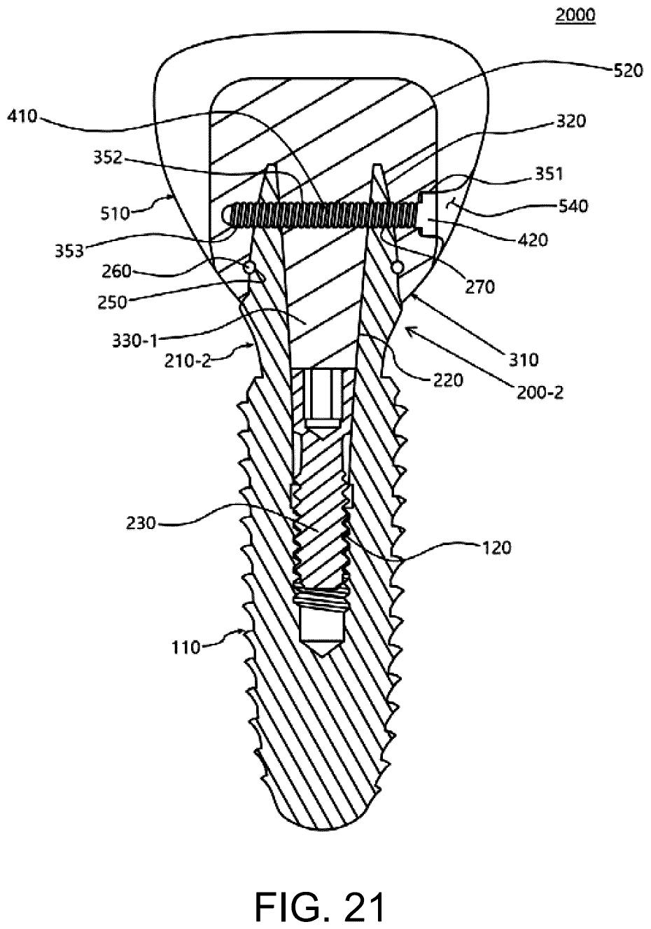

Additionally, FIG. 21 is a front cross-sectional view illustrating a dental implant according to a fourth embodiment of the present disclosure.

Referring to FIG. 21, the dental implant 2000 according to the fourth embodiment of the present disclosure includes a fixture part 100, an abutment part 200-2, a healing sleeve part 300-1, a fixing part 400, and a crown part 500.

In this case, the fixture part 100 in the present embodiment corresponds to the fixture part 100 in the third embodiment described above, and the description of the fixture part 100 in the present embodiment will be replaced with the description of the fixture part 100 in the third embodiment.

Additionally, the abutment part 200-2 may include an abutment body 210-2, an abutment fastening hole 220, a coupling screw 230, a key groove 240, an abutment sealing groove 250, an abutment sealing part 260, and an abutment middle groove 270.

Here, unlike the abutment body 210-1 in the third embodiment, the abutment body 210-2 in the present embodiment is provided integrally with the fixture part 100. More specifically, the abutment body 210-2 extends upward from the upper opening of the fixture part 100.

As the fixture part 100 and the abutment part 200-2 are formed integrally with each other, the introduction of foreign substances that may occur during the assembly process of parts may be prevented, compared to the procedure of assembling the fixture part 100 and the abutment part 200-1, which are separated from each other.

In addition, on the basis of a state in which the fixture part 100 is implanted in the alveolar bone, the abutment body 210-2 may extend to correspond to the height position of the highest end of the gingiva of an affected part. To set the extension length of the abutment part 200-2, a pre-procedure plan may be established on the basis of various intraoral images.

More specifically, various types of oral images may be acquired through various means such as computer tomography (CT) and oral scan before an implant procedure, and these oral images may be matched to form a three-dimensional virtual oral modeling in software.

Additionally, various parts of an implant customized to the virtual oral modeling are virtually designed, and then each part of the implant is manufactured according to a final design, thereby improving design convenience and accuracy.

Additionally, the remaining components of the abutment part 200-2, such as the abutment fastening hole 220, the coupling screw 230, the key groove 240, the abutment sealing groove 250, the abutment sealing part 260, and the abutment middle groove 270 correspond to the components of the same names described above in the third embodiment, and the description of the remaining components of the abutment part 200-2 will be replaced with the information described above for the abutment part 200-1 in the third embodiment.

Additionally, the healing sleeve part 300-1, the fixing part 400, and the crown part 500 in the present embodiment also correspond to the components of the same names described above in the third embodiment, and the description of the remaining components in the present embodiment will be replaced with the information described above in the third embodiment.

In addition, on the basis of the 3D virtual oral modeling mentioned above, a surgical guide for guiding intraoral drilling and insertion of the fixture part 100 may be designed and manufactured.

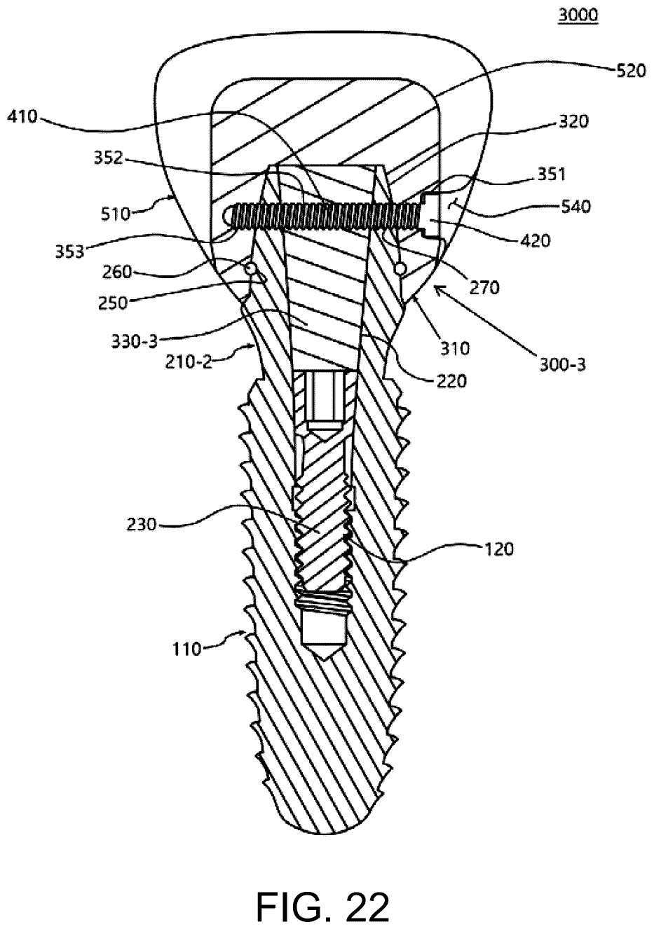

Additionally, FIG. 22 is a front cross-sectional view illustrating a dental implant according to a fifth embodiment of the present disclosure.

Referring to FIG. 22, a dental implant 3000 according to the fifth embodiment of the present disclosure includes a fixture part 100, the abutment part 200-2, a healing sleeve part 300-3, a fixing part 400, and a crown part 500.

In this case, the fixture part 100 and the abutment part 200-2 in the present embodiment correspond to the fixture part 100 and the abutment part 200-2 in the fourth embodiment described above, and the description of the fixture part 100 and the abutment part 200-2 in the present embodiment will be replaced with the description of the components of the same names in the fourth embodiment.

Additionally, the healing sleeve part 300-3 may include a sleeve body 310, a sleeve receiving part 320, an internal insertion part 330-3, a key protrusion part 340, a sleeve entrance groove 351, a sleeve through groove 352, and a sleeve end groove 353.

Here, the sleeve body 310 and the sleeve receiving part 320 correspond to the components of the same names in the other embodiments described above, and the description of the sleeve body 310 and the sleeve receiving part 320 will be replaced with the description of the components of the same names in the other embodiments described above.

Additionally, unlike the internal insertion part 330-1 in the other embodiments, the internal insertion part 330-3 in the present embodiment is provided separately from the sleeve body 310.

Accordingly, after the fixture and abutment procedures, the internal insertion part 330-1 is inserted into the abutment part 200-2, and then the sleeve body 310 is installed to cover the abutment part 200-2. Additionally, the arrangement of the internal insertion part 330-1 and the sleeve body 310 assembled with the abutment part 200-2 corresponds to the arrangement of the internal insertion part 330-1 and the sleeve body 310 in the other embodiments described above.

Additionally, the key protrusion part 340, the sleeve entrance groove 351, the sleeve through groove 352, and the sleeve end groove 353 in the present embodiment are the same as the components of the same names in the other embodiments described above, and the description of the key protrusion part 340, the sleeve entrance groove 351, the sleeve through groove 352, and the sleeve end groove 353 in the present embodiment will be replaced with the description of the components of the same names in the other embodiments described above.

Additionally, the fixing part 400 and the crown part 500 in the present embodiment also correspond to the components of the same names in the other embodiments described above, and the description of the remaining components in the present embodiment will be replaced with the information described above in the other embodiments.

As described above, the main technical idea of the present disclosure is to provide the dental implant, and an embodiment described above with reference to the drawings is only one example, and the scope of the rights of the present disclosure rights will extend not only to the scope of the claims, but also to various equivalent embodiments that may exist.

What is claimed is:

1. A dental implant comprising:
a fixture part implanted in the alveolar bone;
an abutment part coupled to an upper portion of the fixture part;
a crown part coupled to the abutment part to cover the abutment part in a direction downward from an upper portion thereof; and
a fixing part fastened to the crown part and the abutment part by passing therethrough and provided such that a longitudinal axis of the fixing part intersects a longitudinal axis of the abutment part.

2. The dental implant of claim 1, wherein the abutment part comprises an abutment sealing groove formed as a recessed structure along a circumferential direction of an outer circumferential surface thereof; and an abutment sealing part fastened to the abutment sealing groove,
the crown part comprises a crown sealing groove formed as a recessed structure on an inner circumferential surface thereof such that the crown sealing groove is in surface contact with an outer surface of the abutment sealing part protruding to the outside of the abutment sealing groove, and
the abutment sealing part is in close contact with the abutment sealing groove and the crown sealing groove through an elastic restoration action.

3. The dental implant of claim 1, wherein the dental implant further comprises a reinforcing part inserted into the abutment part and penetrated by the fixing part.

4. The dental implant of claim 3, wherein the abutment part comprises: an abutment fastening hole formed through the abutment part along a longitudinal direction thereof from an upper outer surface thereof; an abutment middle hole formed in a direction intersecting with a longitudinal axis of the abutment part; and at least one key groove extending downward while the key groove has a structure extending from an upper open surface edge of the abutment fastening hole in a radially outward direction of the abutment fastening hole,
the crown part comprises a crown middle groove formed in a direction intersecting with a longitudinal axis thereof,
the reinforcing part comprises: a middle through hole formed in a direction intersecting with a longitudinal axis thereof; and a key protrusion part formed as a protruding structure on an outer circumferential surface thereof to guide mutual communication of the abutment middle hole and the middle through hole, with the key protrusion part being coupled to the key groove, and
the fixing part is fastened through the crown middle groove, the abutment middle hole, and the middle through hole.

5. The dental implant of claim 4, wherein the fixture part comprises a fixture screw groove formed along a longitudinal direction thereof from an upper outer surface thereof,
the abutment part comprises a coupling screw configured to fix the abutment part to the fixture part by engaging with the abutment fastening hole and the fixture screw groove, and
the reinforcing part is provided between an upper outer surface of the coupling screw and an upper inner surface of the crown part.

6. A dental implant comprising:
a fixture part implanted in the alveolar bone;
an abutment part provided on an upper portion of the fixture part;
a healing sleeve part provided to cover the abutment part downward from an upper portion thereof;
a crown part provided to cover the healing sleeve part downward from an upper portion thereof; and
a fixing part fastened through the crown part, the healing sleeve part, and the abutment part and provided such that a longitudinal axis of the fixing part intersects with an implanting direction of the fixture part.

7. The dental implant of claim 6, wherein the healing sleeve part comprises an internal insertion part extending from an inner ceiling surface thereof facing an upper opening of the abutment part, and protruding downward to be inserted into the abutment part, and
the fixing part penetrates the internal insertion part.

8. The dental implant of claim 6, wherein the abutment part extends upward from an upper end of the fixture part.

9. The dental implant of claim 8, wherein the abutment part extends to correspond to a height position of a highest end of the gingiva.

10. The dental implant of claim 9, wherein the fixture part comprises a fixture screw groove formed along a longitudinal direction thereof from an upper outer surface thereof,
the abutment part comprises: an abutment body on the upper portion of the fixture part; an abutment fastening hole formed up and down along a longitudinal direction thereof and having opposite open ends; and a coupling screw inserted into the abutment fastening hole and the fixture screw groove to be screwed to the fixture screw groove so that the abutment body is fixed to the fixture part, and
an internal insertion part of the healing sleeve part is inserted into the abutment fastening hole and elastically presses an upper surface of the coupling screw downward.
